(19) United States
(12) Patent Application Publication
(10) Pub. No.: US 2006/0274531 A1
(43) Pub. Date: Dec. 7, 2006

(54) LED luminaire and arrangement comprising a luminaire body and an LED operating device

(75) Inventors: Christian Kopf, Munchen (DE); Florian Wildner, Munchen (DE); Robert Wolf, Deuringen (DE)

Correspondence Address: OSRAM SYLVANIA INC, 100 ENDICOTT STREET, DANVERS, MA, 01923, US

(73) Assignee: PATENT-TREUHAND-GESELLSCHAFT FUR ELEKTRISCHE GLUHLAMPEN MBH, MUNCHEN (DE)

(21) Appl. No.: 11/445,261

(22) Filed: Jun. 2, 2006

(30) Foreign Application Priority Data
Jun. 3, 2005 (DE) 102005025623.6

(51) Int. Cl. F21V 29/00

(52) U.S. Cl. 362/294

(57) ABSTRACT

The invention discloses an LED luminaire, in the case of which an LED module is applied to the luminaire body such that the height of the luminaire body and the LED module is ≦8 mm and the luminaire body at least partially forms the heat sink for the LED module. In this case, LED modules having power ratings of ≧3 watts are used. LED operating devices can be used for voltage supply purposes which form an outer face section of an arrangement comprising a luminaire body and an LED operating device, the total height of the luminaire body and LED operating device being ≦10 mm, and the LED operating device preferably being cooled via the luminaire body.

### TECHNICAL FIELD

The present invention relates to LED luminaires having a luminaire body and at least one LED module, which is applied to the luminaire body. It relates further to an arrangement comprising a luminaire body and an LED operating device.

### BACKGROUND ART

LED modules such as DRAGONtape®, DRAGONpuck® and DRAGONeye® are known which are used, for example, as shop and furniture luminaires, as reading lights and as spotlights for entertainment tasks or as a light head for miniradiators or as pilot lighting. In the case of such LED modules, the illuminance is lower and the light quality is poorer than in the case of burners. In addition, even the high-flux LED Golden Dragon® used already provides a minimum installation height which needs to be taken into consideration when designing the luminaire.

In the case of burners, the conventional axial arrangement of the lamp, the reflector and the lampholder prevents the luminaires from having a low height.

### DISCLOSURE OF THE INVENTION

The object of the present invention consists in eliminating the disadvantages of the prior art and providing an LED luminaire, whose dimensions are small and with which it is possible to realize a high illuminance and light quality. In addition, the thermal response should be improved. Furthermore, an arrangement comprising a luminaire body and an LED operating device should be matched to these requirements, and the LED operating device should be capable of being connected to the luminaire body in a simple manner and should likewise have an advantageous thermal response.

This object is achieved by the luminaire having a luminaire body and at least one LED module, which is applied to the luminaire body, wherein the luminaire body, with the at least one LED module, has a height of ≦8 mm, and the luminaire body at least partially forms the heat sink for the LED module. The further object is achieved by the arrangement comprising a luminaire body and an LED operating device, it being possible for the LED operating device to be inserted in a receptacle of the luminaire body in an interlocking or force-fitting manner such that it forms an outer face section of the arrangement. Preferable Developments according to the invention are the subject matter of the dependent claims.

The invention provides a luminaire having a luminaire body and at least one LED module, which is applied to the luminaire body, the installation height of the luminaire body and the LED module being ≦8 mm, and at least one section of the luminaire body forming the heat sink for the LED module. Owing to the holding function and the heat sink function of the luminaire body, a luminaire having a small thickness can be implemented, as a result of which there are greater degrees of freedom in terms of design for the luminaire, and a reduction in the temperature level of the luminaire is achieved. It is thus possible for the luminaire to be in the form of, for example, a table lamp, to be designed for under-cupboard illumination, to be in the form of a surface-mounted furniture luminaire or a ceiling-mounted luminaire, the conventional large dimensions being avoided owing to the axial design of the lamp, the reflector and the lampholder. The LED modules in the form of punctiform light sources allow for targeted illumination of, for example, desks.

The LED module is preferably produced using the chip-on-board technology and has a large number of light-emitting diodes having a total power rating of ≧3 watts, preferably ≧5 watts. The chip-on-board technology allows for a thickness of the LED modules of a few millimeters, allows for the use of white and RGB LED modules and allows for a luminous efficiency which has not been possible to realize until now using luminaires having this installation height, both in terms of illuminance and light quality.

An optical system is preferably provided directly above the LED module for the purpose of deflecting light and for the purpose of protecting the LED module, with the result that it is possible to realize a desired light distribution with a low installation height.

The installation height of the luminaire body and the LED module can be further reduced by recessing the LED module into the luminaire body.

An anti-glare device, for example in the form of an anti-glare ring, in the surrounding area of the LED module is advantageous for glare suppression purposes. In this case, the anti-glare device preferably has a partially transparent component, for example consisting of polycarbonate, as a result of which the visual appearance of the luminaire is also advantageous. A visually attractive luminaire is likewise achieved by suitably selecting the material for the luminaire body, for example by selecting an aluminum or copper plate or by it being in the form of an extruded section. The use of anodized aluminum is particularly favorable owing to the surface hardness achieved at the same time as the attractive visual appearance. The anodization is likewise used owing to the better heat dissipation.

The thickness of the luminaire body can be designed to be low owing to the use of foil conductors for power supply purposes, since it is possible to dispense with introducing channels for cables in the luminaire body. The advantage when using cables in a channel in the luminaire body for the power supply to the LED module consists in the possibility of transmitting higher powers and in the use of the channel likewise for recessing the LED module, in order that a low total installation height is achieved.

In addition, the invention provides an arrangement comprising a luminaire body and an LED operating device, in the case of which the LED operating device can be inserted in a receptacle or cutout in the luminaire body in an interlocking and/or force-fitting manner such that the LED operating device forms an outer face section of the arrangement. In contrast to the prior art, in which the operating devices have usually been provided in a manner in which they are hidden owing to the high installation height, it is now possible for the LED operating device to be used at least partially for the outer configuration of the luminaire. The integral formation of the luminaire body and the LED operating device makes it possible to form compact luminaires which are supplied with voltage via a power cable.

It is particularly preferred if at least one side face of the luminaire body extends flush with the LED operating device, and the height of the LED operating device on the luminaire body is ≦10 mm. In this manner, luminaires can be implemented, in the case of which the LED operating device cannot be perceived as a separate component. In order to achieve these low installation heights, the use of a piezoelectric transformer is preferred since, in this manner, it is possible to achieve a high degree of efficiency without any electromagnetic noise in the case of a power rating for LED modules of up to 16 watts, in addition to the low installation height.

In accordance with one embodiment of the invention, two opposite side faces of the luminaire body extend essentially flush with side faces of the LED operating device, as a result of which the LED operating device can no longer be perceived as a separate unit, even when viewed from a plurality of directions. Particularly preferred is a flush arrangement of three side faces of the luminaire body and the LED operating device such that a large proportion of the outer face of the LED operating device appears to the observer to be part of the luminaire body.

The LED operating device can be in the form of a mechanical and electrical connecting piece between two luminaire body sections of a luminaire strip. In this manner, each luminaire body section can have a dedicated LED operating device assigned to it, as a result of which, despite the large number of LED modules used, a low power rating can be realized for each LED operating device and thus a low installation height combined with a low heat output. It is particularly advantageous if the luminaire body is used for cooling the LED operating device, with the result that a separate heat sink for the LED operating device is not required.

In accordance with one embodiment of the present invention, the LED operating device has a dovetailed cutout for the purpose of pushing the LED operating device onto the luminaire body, as a result of which it is possible to use a solid and thus robust luminaire body.

It is preferable according to the invention if the above-described luminaire is provided with an above-described LED operating device. Such a design makes it possible to ensure that protected contact is made between the LED operating device, for example via contacts on the inner side of the cutout, and the luminaire body, for example connection faces at the end of flat conductors. As an alternative to this, the electrical contact is made between the LED operating device and the luminaire body by means of electrical connections in the longitudinal direction of the luminaire body, with the result that it is possible to realize an electrical and mechanical connection in a simple manner with an axial shift of the LED operating device and the luminaire body.

### BRIEF DESCRIPTION OF THE DRAWINGS

The invention will be explained in more detail below with reference to preferred exemplary embodiments. In the drawings:

FIG. 1 shows an illumination unit according to the invention of a luminaire corresponding to a first exemplary embodiment of the invention,

FIG. 2 shows an illumination unit according to the invention of a luminaire corresponding to a second exemplary embodiment of the invention,

FIGS. 3A, 3B, 3C and 3D show a first exemplary arrangement of illumination units in a luminaire corresponding to the first or second exemplary embodiment of the invention,

FIGS. 4, 5, 6 and 7 show a second, third, fourth and fifth arrangement for the illumination units in a luminaire corresponding to the first or second exemplary embodiment of the invention,

FIGS. 8A and 8B show a section of a luminaire corresponding to a third exemplary embodiment of the invention,

FIG. 9 shows a section of a luminaire corresponding to a fourth exemplary embodiment of the invention,

FIG. 10 shows a cable arrangement which can be used in a luminaire according to the invention, and

FIGS. 11A and 11B show a section of a luminaire corresponding to a fifth exemplary embodiment of the invention.

### BEST MODE FOR CARRYING OUT THE INVENTION

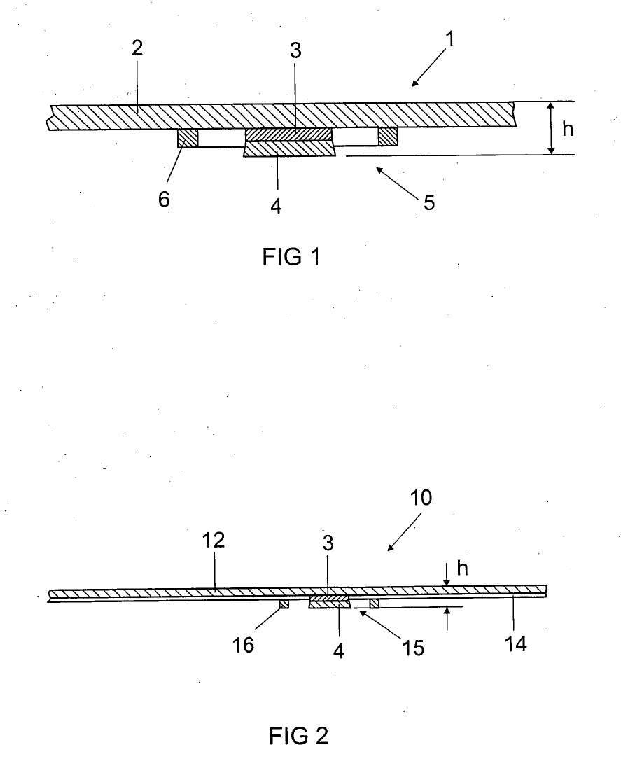

FIG. 1 shows a detail of a luminaire 1 having a luminaire body 2, to which an illumination unit 5 is applied, corresponding to the first exemplary embodiment.

The luminaire body 2 consists of anodized aluminum in FIG. 1. As an alternative to this, the luminaire body may, for example, also be in the form of a bent or straight extruded section or in the form of a bent metal part made from aluminum or copper. In this case, the material alloy and the surface treatment are optimized as regards the best possible heat conduction and heat dissipation with respect to the illumination unit 5.

The illumination unit 5 has an LED module 3, which is applied to the surface of the luminaire body 2 via a thermally conductive material, such as a two-component adhesive, or a thermally conductive paste, in interaction with a spring. As a result, the luminaire body 2 has both a bearing function and the function as a heat sink for the LED module 3.

Used as the LED modules are modules having power ratings of ≧3 W, preferably ≧5 W. Such LED modules are manufactured without a housing using the chip-on-board technology. Lamina Ceramics, Westampton, N.J. USA manufactures, for example, such LED modules using the LTCC-M technology (low-temperature co-fired ceramic on metal technology) as Lamina Super-Bright LED Arrays under the type designations BL 2000, BL 3000 and BL 4000 in such a manner that ceramic layers and a primary optical system are applied to a metal with the n-p junctions of a plurality of LEDs.

Such LED modules have a low height of a few millimeters and a high luminous efficiency and make it possible for the heat produced by the operation of the large number of LEDs on the LED module to be dissipated efficiently via its rear side, which consists of metal. Owing to the use of the LED technology, the temperature level of the luminaire is reduced in comparison to conventional burners, which allows for the use of more temperature-sensitive materials in the surrounding area of the LED module 3.

Furthermore, such LED modules 3 are available not only for white light, but also as RGB LEDs and for the colors red, green, blue and yellow.

Owing to thermal coupling between the LED module 3 and the luminaire body 2 via the thermally conductive material, the luminaire body 2 has the function of the heat sink for the LED module 3.

An optical system 4 is applied to the opposite side of the LED module 3 to the luminaire body 2, by means of which optical system the desired radiation angle of the illumination unit can be implemented. In the present exemplary embodiment, the optical system causes a radiation angle of the LED module of 120° to be converted to a radiation angle of the illumination unit of 90°. In addition to the light deflection, the flat optical system 4 is also used for protecting the LED module 3.

The LED module 3 has lateral glare suppression owing to an anti-glare ring 6 which is applied to the luminaire body 2. In the first exemplary embodiment, the anti-glare ring 6 is partially transparent, for which purpose polycarbonate can advantageously be used. Alternatively, a metallic or other opaque anti-glare device is used.

In the first exemplary embodiment, the luminaire 1 is supplied with voltage by means of foil conductors or flat conductors applied to the luminaire body 2 or by means of conductor tracks which are applied chemically or galvanically directly to the luminaire body 2.

Owing to the low installation height of the LED module 3 with the optical system 4 applied and owing to the heat dissipation via the luminaire body 2, the present invention makes it possible to realize luminaires having installation heights of the luminaire body, the LED module and the optical system of h≦8 mm, as is illustrated in FIG. 1, the luminaire having a punctiform light source, by means of which it is possible to implement powers of ≧3 W, which results in new use areas for the LED luminaires according to the invention. The use of foil conductors assists in achieving the low installation height.

A luminaire according to the invention is thus suitable for a large number of illumination applications, for example as a table lamp, a pendant luminaire, a wall-mounted luminaire, a ceiling-mounted luminaire, a recessed floor luminaire, a surface-mounted furniture luminaire and an under-cupboard luminaire.

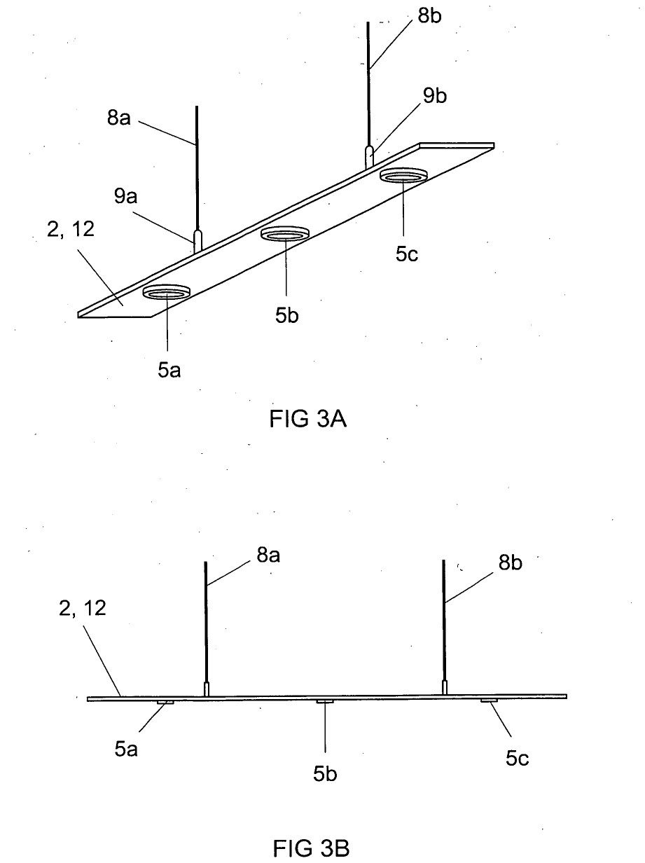

FIG. 2 shows a detail of a luminaire 10 having a luminaire body 12, to which an illumination unit 15 is applied, corresponding to the second exemplary embodiment. As in the first exemplary embodiment, the illumination unit 15 has an LED module 3, an optical system 4 and an anti-glare ring 16.

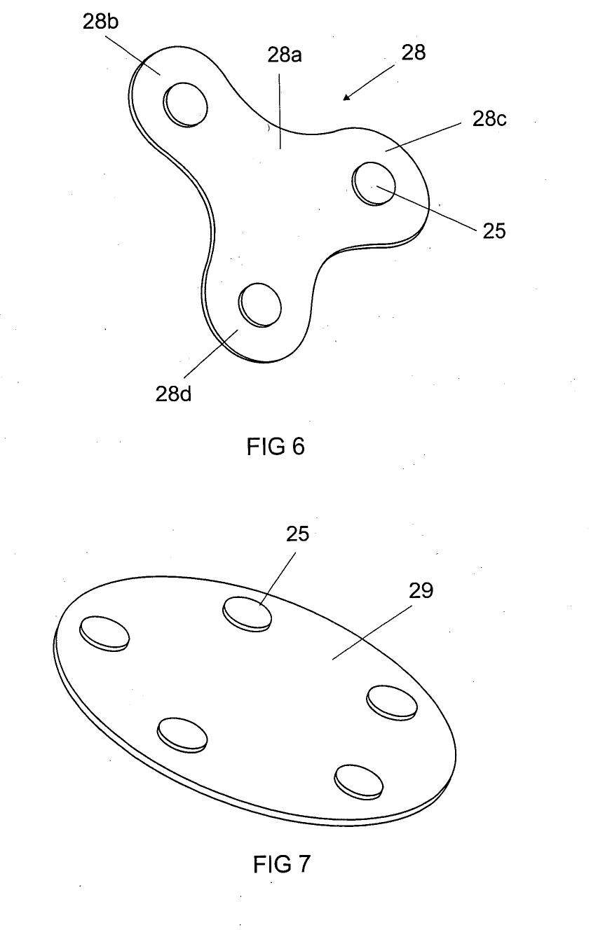

In accordance with the second exemplary embodiment, the luminaire 10 differs from the luminaire 1 of the first exemplary embodiment in terms of voltage supply. While in the first exemplary embodiment foil conductors are used, as is shown, for example, in FIG. 8A, in the second exemplary embodiment a channel 14 is introduced into the luminaire body 12 for insulated cables, by means of which the voltage is supplied to the LED module 3. The LED module 3 with the optical system 4 arranged thereon is also located in the channel 14, as a result of which the installation height of the illumination unit 15 can be further reduced compared to the first exemplary embodiment. The depth of the channel 14 can be designed in such a manner that glare suppression of the LED module 3 is carried out by the channel 14 itself. FIG. 2 also illustrates an anti-glare ring 16, which may be omitted depending on the depth of the channel 14 and the requirements for glare suppression.

In the second exemplary embodiment too, luminaires having installation heights of the luminaire body, the LED module and the optical system of h≦8 mm can be implemented, as is shown in FIG. 2.

The channel 14 in the second exemplary embodiment can be closed by means of a cover (not illustrated) in order to provide a visually more attractive design for the luminaire according to the invention and in order to assist in the glare suppression.

As an alternative to this, a cable channel may be provided on that side of the luminaire body 12 which is opposite the illumination unit. It is advantageous that, for example in the case of ceiling-mounted luminaires, a cover for the channel is not necessarily required for a visually attractive design of the luminaire. However, this does increase the installation height of the luminaire since the LED module cannot be introduced into the channel.

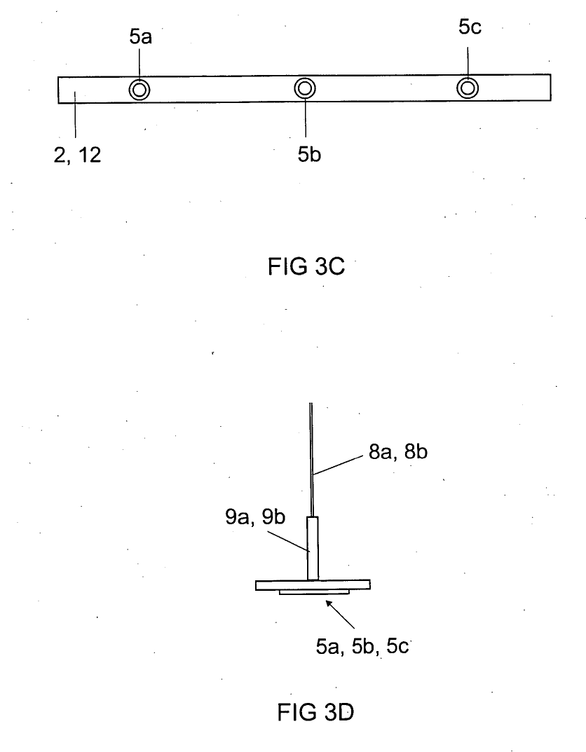

FIGS. 3A to 3D show schematics of a first exemplary arrangement of illumination units 5a, 5b, 5c of a luminaire corresponding to the first and second exemplary embodiments, FIG. 3A illustrating a perspective view, FIG. 3B a side view in the longitudinal direction, FIG. 3C a view from below and FIG. 3D a side view in the transverse direction.

The luminaire body 2, 12 is in this case, as a rectangular flat material made from anodized aluminum, in the form of a ceiling-mounted luminaire, the luminaire body 2, 12 being fixed to the ceiling via two current-carrying suspension means 8a, 8b and two guide sleeves 9a, 9b. Illumination units 5a, 5b, 5c are fixed, corresponding to the first or second exemplary embodiment, with a downwardly pointing radiation direction at regular intervals on the luminaire body. The illumination units 5a, 5b, 5c are punctiform light sources which make possible targeted illumination of desired areas.

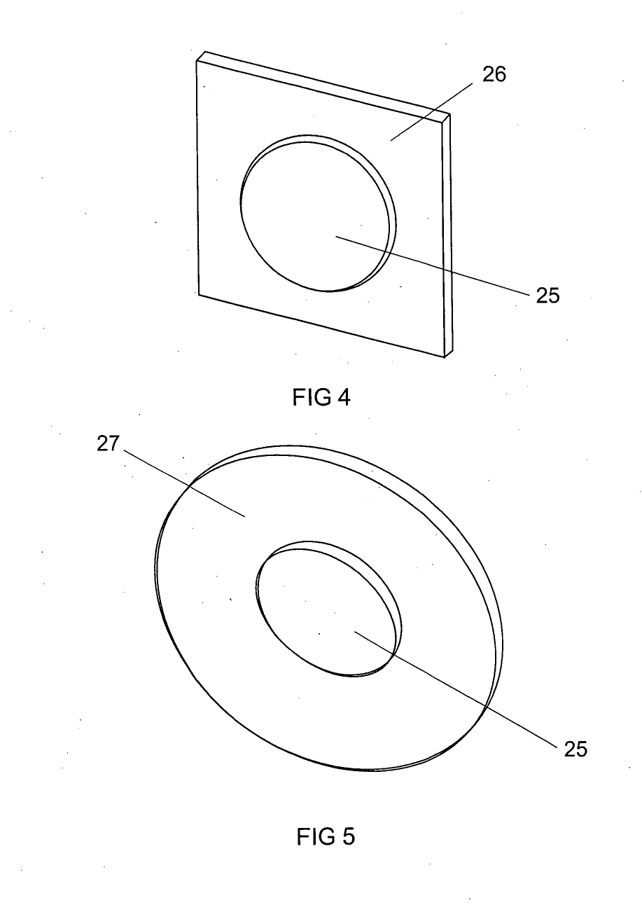

FIGS. 4 to 7 show schematics of a second, third, fourth and fifth exemplary arrangement of illumination units 25 of a luminaire corresponding to the first and second exemplary embodiments. The illumination unit 25 is either the illumination unit 5 or the illumination unit 15 in the first or second exemplary embodiment.

In the second arrangement shown in FIG. 4, a luminaire body 26 is provided which is square in plan view, the illumination unit 25 being arranged in the center of said luminaire body 26, while in the third arrangement shown in FIG. 5, the luminaire body 27 is circular in plan view, the center point of the illumination unit 25 being located at the center point of the circle.

The fourth arrangement shown in FIG. 6 represents a development of the arrangement shown in FIG. 5 in such a manner that three circular luminaire bodies 27 from FIG. 5 are combined to form one luminaire body 28 in a manner such that they merge in a central section 28a of the luminaire body 28. In this case, three arms 28b, 28c, 28d result which can be moved out of the plane of the central section 28a independently of one another, with the result that the punctiform light sources can radiate toward one another or away from another.

The fifth arrangement shown in FIG. 7 shows a circular luminaire body 29 which has five illumination units 25 provided close to its circumference. Owing to the circular arrangement of the punctiform light sources, larger areas, for example tables, can be illuminated in a targeted manner with a high luminous efficiency.

In the first to the fifth arrangement for the illumination arrangement corresponding to FIGS. 3A to 3D and corresponding to FIGS. 4, 5, 6 and 7, the LED operating device is not provided on the luminaire body but is fitted to the wall or the ceiling to which the luminaire body is fixed via the suspension means.

In the third, fourth and fifth exemplary embodiments, which will be described below, the LED operating device in the form of a flat transformer is integrated in the luminaire body instead of an external LED operating device for the purpose of feeding the LED modules in a current- and voltage-regulated manner.

FIGS. 8A and 8B show a luminaire corresponding to a third exemplary embodiment of the present invention. More precisely, the third exemplary embodiment represents a development of the luminaire corresponding to the first exemplary embodiment.

As is illustrated in FIG. 8A, in the third exemplary embodiment a cutout 20, which is delimited by two lateral guides 22a, 22b, is provided in a front end of the luminaire body 2 from the first exemplary embodiment. A plug-in element 24 is located between the two lateral guides 22a, 22b in such a manner that connections of the plug-in element are electrically connected to a flat conductor 23. The flat conductor 23 is electrically connected to an illumination unit (not illustrated in FIG. 8A) corresponding to the first exemplary embodiment.

FIG. 8B shows the LED operating device 30 from the third exemplary embodiment which is provided with a connection cable 34. This LED operating device 30 has an essentially square design having two side faces 30a, 30b, which are opposite one another, and two side faces 30c, 30d, which are opposite one another and are offset through 90° with respect to the side faces 30a, 30b. Connection elements 32a, 32b are recessed into the side faces 30c, 30d in such a manner that the connection element 32a of the LED operating device 30 with the lateral guide 22a of the luminaire body 2 and the connection element 32b of the LED operating device 30 with the lateral guide 22b of the luminaire body 2 make it possible for the LED operating device 30 to be inserted and held in the luminaire body 2.

In the embodiment illustrated, the lateral guides 22a, 22b of the luminaire body 2 are in the form of grooves in a tongue-and-groove connection, while the connection elements 32a, 32b of the LED operating device 30 are in the form of tongues in the tongue-and-groove connection. However, the present invention is not restricted to this, rather any desired interacting lateral guides and connection elements 22a, 32a, 22b, 32b can be used.

Connections (not illustrated in FIG. 8A) are provided at the front end of the LED operating device 30, which is opposite the connection cable 34, and can be brought into engagement with the plug-in element 24 such that the LED operating device is electrically connected to the flat conductor 23 and is mechanically coupled to the luminaire body 2.

The connection elements 32a, 32b of the LED operating device 30 are recessed into the side faces 30c, 30d of the LED operating device 30 so deeply that the side face 30c of the LED operating device 30 applied to the luminaire body 2 extends flush with the side face 2c of the luminaire body 2 and that the side face 30d of the LED operating device 30 applied to the luminaire body 2 extends flush with the side face 2d of the luminaire body 2 if the LED operating device 30 is inserted in the luminaire body 2. To this end, the length T1 of the connection elements 32a, 32b is identical to the depth T1 of the cutout 20 in the luminaire body 2 in the axial direction.

In addition, the height h1 of the luminaire body 2 is equal to the height h1 of the LED operating device 30, with the result that the side faces 30a and 30b of the LED operating device 30 have the same distance from one another as the side faces 2a, 2b of the luminaire body 2. The plug-in element 24 has the same height h1. The side faces 2a and 30a and the side faces 2b and 30b therefore extend flush with respect to the respective outer face of the plug-in element 24 when the LED operating device 30 is inserted in the luminaire body 2. The height h1 of the LED operating device 30 is ≦10 mm.

In order to achieve the low installation height for the LED operating device 30, a flat, piezoelectric transformer is used, as is used, for example, in the charging device PT3 by Friwo, Ostbevern or as is produced by EPCOS, Deutschlandsberg. Such transformers make it possible to achieve output powers of, for example, 3 W. However, even higher output powers can be achieved, for example up to approximately 16 W.

The connection elements 32a, 32b and the lateral guides 22a, 22b are used for guidance purposes when the LED operating device 30 is inserted in the luminaire body 2, are provided with a latching-in section in order that the LED operating device 30 cannot be moved out of the luminaire body 2 without being impeded and are also used for heat transfer purposes between the LED operating device 30 and the luminaire body 2. In this manner, the luminaire body 2 not only acts as a heat sink for the illumination units 5 but likewise acts as a heat sink for the LED operating device 30.

In the third exemplary embodiment, the LED operating device 30 is in the form of an end piece.

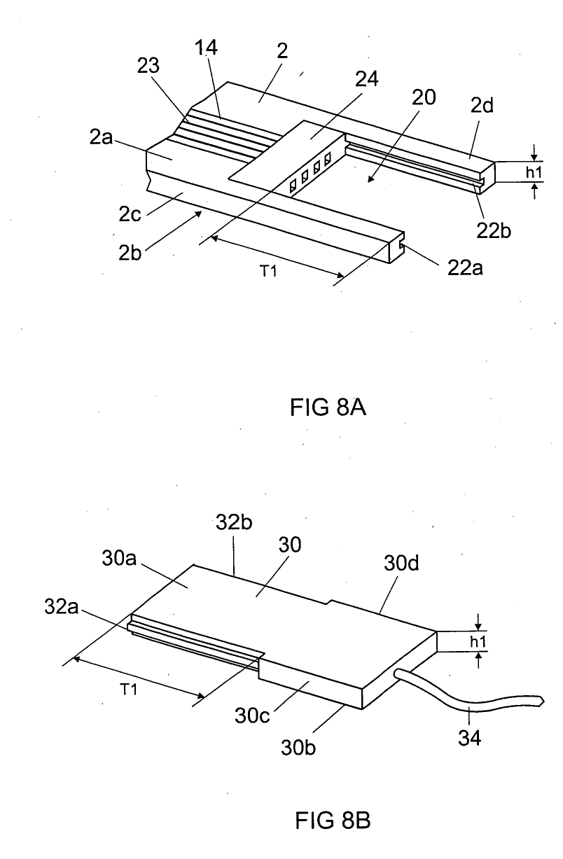

FIG. 9 represents, with the fourth exemplary embodiment, a modification of the third exemplary embodiment. In the fourth exemplary embodiment, an LED operating device 40 is provided in the form of an intermediate piece, in addition to the LED operating device 30.

The LED operating device 40 has a longitudinal dimension L, which corresponds to twice the dimension T1 of the cutout 20, and has two side faces 40a, 40b, which are opposite one another, and connection elements 42a, 42b, which are opposite one another between said side faces 40a, 40b. Plug-in elements are formed at the front ends 41a, 41b of the LED operating device 40, the plug-in elements being formed at the front end 41a such that they can be brought into engagement with the plug-in element 24 of the luminaire body 2 shown in FIG. 8A.

In the fourth exemplary embodiment shown in FIG. 9, a cutout 60 having a depth T2 is provided in the luminaire body 2 of the first exemplary embodiment in addition to the cutout 20 in the opposite end section, said cutout 60 being equal to the depth T1 of the cutout 20. The cutout 60 is delimited by two lateral guides 62a, 62b and a plug-in element 64, which can be brought into electrical and mechanical engagement with the front end 41b of the LED operating device 40. The plug-in element 64 is connected to flat conductors (not shown), it being possible for the system voltage or a transformed voltage to be fed to the LED operating device 40 via the flat conductors.

If the LED operating device 40 is introduced both into the cutout 20 of the third exemplary embodiment and into the cutout 60, the faces 40a, 40b of the LED operating device 40 extend flush with the faces 2a, 2b and 2′a, 2′b of the luminaire body 2, 2′. It is thus possible to extend a large number of luminaire bodies to form a luminaire strip owing to the LED operating device 40, each luminaire body being supplied with voltage either via one of the LED operating devices 40 in the luminaire strip or via the LED operating device 30, which has the function of the end piece.

In order to avoid a termination at one end with the cutout 60 in the case of a luminaire strip, a termination piece without any electrical function can be introduced into this cutout 60, which termination piece allows for a front end which terminates flush and faces 2′a, 2′b which extend flush.

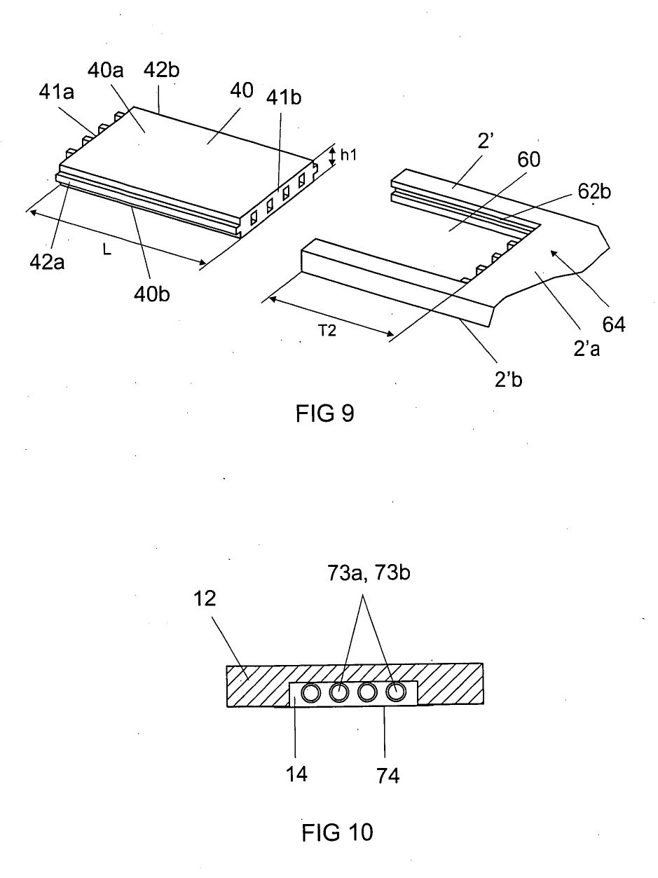

FIG. 10 shows an alternative refinement in the third and fourth exemplary embodiments using the structure of the second exemplary embodiment, which is shown in FIG. 2. More precisely, in this development insulated cables 73a, 73b are provided in the channel 14 of the luminaire body 12 instead of the flat conductor 23 of the first exemplary embodiment, and these insulated cables 73a, 73b are connected to the plug-in elements 24 and 64 and the illumination unit 15 shown in FIG. 2. The channel 14 is covered by a shield 74 in order that the cables 73a, 73b remain in the channel 14 and there is thus a visually attractive termination at this end of the luminaire body 12.

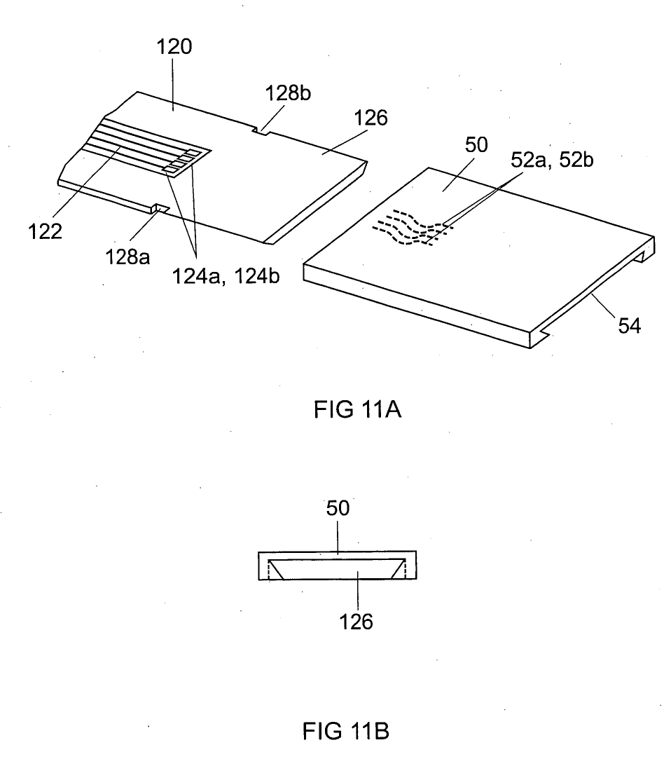

FIGS. 11A and 11B show a fifth exemplary embodiment of the present invention with an LED operating device 50. The LED operating device 50 has a piezoelectric transformer, in the same manner as the LED operating devices 30 and 40 of the second and third exemplary embodiments. In contrast to the third and fourth exemplary embodiments, in which the LED operating device has been inserted in a cutout in the luminaire body, the LED operating device 50 in the fifth exemplary embodiment is pushed onto the luminaire body 120 such that the LED operating device 50 engages around the luminaire body 120 at one end section.

The LED operating device 50 is essentially in the form of a square, into which a dovetailed cutout 54 is introduced which can be brought into engagement with the dovetailed formation 126 on the luminaire body 120 by means of being pushed on. In this case, projections (not illustrated in FIG. 11A) in the dovetailed cutout 54 engage behind depressions 128a, 128b formed in the transverse direction of the luminaire body 120 such that the LED operating device 50 is secured on the luminaire body 120.

Contacts 52a, 52b are formed on that side of the LED operating device which points toward the dovetailed cutout 54 and can be brought into contact with connection faces 124a, 124b of a flat conductor 122 in order that the LED operating device 50 can supply voltage to the illumination units which are connected via the flat conductor 122.

In the case of the LED operating device 50 of the fifth exemplary embodiment too, the connection with the luminaire body 120 takes place in such a manner that the luminaire body 120 acts as a heat sink for the LED operating device.

As an alternative to flat conductors 122, in the fifth exemplary embodiment the connection faces 124a, 124b can be connected to insulated cables 73a, 73b in a channel in the luminaire body.

The present invention is not restricted to the described connection systems between the luminaire body and the LED operating device, rather any desired holding, plug-in and coupling system can be used for the purpose of electrically and mechanically connecting the LED operating device to the luminaire body.

The LED operating device from the third, fourth and fifth exemplary embodiments prevents the ballast from becoming displaced and at the same time reduces the previous installation height of the ballasts from 15-30 mm to ≦10 mm in the state in which it is applied to the luminaire body, effective cooling of the LED operating device being ensured in the process. In this case, the LED operating device forms at least partially an outer face of the luminaire.

The invention discloses an LED luminaire, in the case of which an LED module (3) is applied to the luminaire body (2) such that the height of the luminaire body and the LED module is ≦8 mm and the luminaire body (2) at least partially forms the heat sink for the LED module (3). In this case, LED modules having power ratings of ≧3 watts are used. LED operating devices can be used for voltage supply purposes which form an outer face section of an arrangement comprising a luminaire body and an LED operating device, the total height of the luminaire body and LED operating device being ≦10 mm, and the LED operating device preferably being cooled via the luminaire body.

1. A luminaire having a luminaire body and at least one LED module, which is applied to the luminaire body, wherein the luminaire body, with the at least one LED module, has a height of ≦8 mm, and the luminaire body at least partially forms the heat sink for the LED module.

2. The luminaire as claimed in claim 1, the LED module having been produced using the chip-on-board technology, having a large number of light-emitting diodes and having a power rating of ≧3 watts, preferably ≧5 watts.

3. The luminaire as claimed in claim 1 having an optical system, which is provided directly above the LED module, for the purpose of deflecting light and for the purpose of protecting the LED module, the height h of the luminaire body with the LED module and the optical system being ≦8 mm.

4. The luminaire as claimed in claim 1, the LED module being recessed into the luminaire body.

5. The luminaire as claimed in claim 1, an anti-glare device being provided on the luminaire body so as to at least partially surround the LED module.

6. The luminaire as claimed in claim 5, the anti-glare device having a partially transparent component.

7. The luminaire as claimed in claim 1, the luminaire body having an aluminum or copper plate or an extruded section.

8. The luminaire as claimed in claim 1, the power supply to the LED module being provided by means of flat conductors on the luminaire body.

9. The luminaire as claimed in claim 1, the power supply to the LED module being formed by cables in at least one channel in the luminaire body.

10. An arrangement comprising a luminaire body and an LED operating device, it being possible for the LED operating device to be inserted in a receptacle of the luminaire body in an interlocking or force-fitting manner such that it forms an outer face section of the arrangement.

11. The arrangement as claimed in claim 10, at least one side face of the luminaire body extending flush with the LED operating device, and the height of the LED operating device, which has been applied to the luminaire body, together with the luminaire body, being ≦10 mm.

12. The arrangement as claimed in claim 10, the LED operating device having a piezoelectric transformer.

13. The arrangement as claimed in claim 10, it being possible for the LED operating device to be inserted in the receptacle in the luminaire body in such a manner that two opposite side faces of the luminaire body extend essentially flush with the LED operating device.

14. The arrangement as claimed in claim 13, the LED operating device being in the form of an end piece in such a manner that at least three side faces of said LED operating device extend flush with at least three side faces of the luminaire body in the state in which the LED operating device is inserted in the luminaire body.

15. The arrangement as claimed in claim 13, the LED operating device being in the form of a mechanical and electrical connecting piece between two luminaire body sections, and its longitudinal dimension L being approximately the sum of the depths T1, T2 of the respective cutouts in each of the luminaire body sections.

16. The arrangement as claimed in claim 10, the LED operating device being designed in such a manner that the LED operating device can be cooled at least partially by the luminaire body.

17. The arrangement as claimed in claim 10, the LED operating device having a preferably dovetailed cutout, it being possible for the LED operating device to be pushed onto the luminaire body via said cutout.

18. The luminaire as claimed in claim 1 having an arrangement comprising a luminaire body and an LED operating device, it being possible for the LED operating device to be inserted in a receptacle of the luminaire body in an interlocking or force-fitting manner such that it forms an outer face section of the arrangement.

19. The luminaire as claimed in claim 18, the LED operating device having resilient contacts, which can be brought into contact with connection faces of flat conductors on the surface of the luminaire body in the state in which the LED operating device has been pushed onto the luminaire body.

20. The luminaire as claimed in claim 18, the luminaire body having electrical connections in its longitudinal direction, which can be connected to electrical connections of the LED operating device in the longitudinal direction of the luminaire body.
